(19) United States
(12) Patent Application Publication
(10) Pub. No.: US 2015/0159602 A1
(43) Pub. Date: Jun. 11, 2015

(54) Fluid Guiding Element of an Air Intake System of an Engine

(71) Applicant: MANN+HUMMEL GMBH, Ludwigsburg (DE)

(72) Inventor: Pedro Miguel Pereira Madeira, Bietigheim-Bissingen (DE)

(21) Appl. No.: 14/561,440

(22) Filed: Dec. 5, 2014

(30) Foreign Application Priority Data
Dec. 5, 2013 (DE) 10 2013 018 163.1

(51) Int. Cl. F02M 35/10

(52) U.S. Cl. CPC F02M 35/10347; F02M 35/10321; F02M 35/10334

(57) ABSTRACT

In a method for producing a fluid guiding element of an air intake system of an engine, a polymer is melted to a melted polymer material. A foam-generating foaming agent is added to the melted polymer material. The melted polymer material together with the foaming agent is molded to a fluid guiding element by forming a polymer foam. Molding is preferably done by injection molding in an injection mold.

### BACKGROUND OF THE INVENTION

The invention concerns a method for producing a fluid guiding element of an air intake system of an engine as well as a fluid guiding element of an air intake system of an engine.

It is known to produce plastic elements of foamed polymer materials.

For example, DE 197 40 472 B4 discloses to produce expanded polypropylene particles. In this context, a volatile foaming agent in aqueous suspension is used for foaming.

U.S. Pat. No. 7,838,108 B2 discloses a device for producing a foamed polymer material, wherein the pores of the foamed polymer material have a diameter between 10 nm and 500 nm.

EP 0 801 097 B1 discloses the production of an expanded molded plastic part. When producing the molded plastic part, a “foaming agent batch” is used for foaming the polymer material.

Moreover, U.S. Pat. No. 6,030,696 A discloses a method for producing a polymer foam material in which propane is employed as a foaming agent.

EP 1 503 898 B1 discloses a device for producing foamed polymer materials in which carbon dioxide is used as a foaming agent.

US 2010/0189972 A1 discloses foamed cover panel elements of synthetic material for the interior of a motor vehicle. The cover panel elements serve as support elements as well as for damping vehicle noise.

Finally, EP 1 741 583 B1 discloses an air guiding element for motor vehicles for guiding hot air from the engine compartment into the interior of the vehicle. The known air guiding element is comprised of a foamed synthetic material and is produced by injection molding.

The invention concerns in contrast thereto a fluid guiding element of an air intake system of an engine. Since the air must be supplied to the internal combustion engine as cold as possible in order to achieve a high efficiency, the known fluid guiding elements for air intake systems of engines comprise a massive fluid guiding element body, i.e., formed of solid material, that is produced by an injection molding method and is surrounded with insulating layers or films, for example, of a textile material or aluminum.

The manufacture of such an “encased” fluid guiding element is however relatively expensive because the manufacturing time for “encasing” the fluid guiding element body is very long. Moreover, mounting of such a fluid guiding element in the vehicle is made more difficult due to the additional insulating layers. Finally, such a fluid guiding element, due to the additional layers, has an appearance is not very attractive that with regard to visual and haptic considerations.

### SUMMARY OF THE INVENTION

It is therefore the object of the invention to provide an inexpensively producible fluid guiding element of an air intake system of an engine that has thermally insulating properties.

This object is solved by a method for producing a fluid guiding element with the method steps of melting a polymer; adding a foam-generating foaming agent to the melted polymer material; and molding the melted polymer material with the foaming agent to a fluid guiding element of an air intake system of an engine by forming a polymer foam.

The object is further solved by a fluid guiding element that is formed of a foamed polymer material.

The dependent claims provide expedient further embodiments of the invention.

The method for producing a fluid guiding element of an air intake system of an engine comprises thus the following method steps that are sequentially performed:

a) melting a polymer;

b) adding a foam-forming foaming agent to the melted polymer material;

c) molding the melted polymer material with the foaming agent to a fluid guiding element of an air intake system of an engine by forming a polymer foam.

With the method according to the invention, a foamed fluid guiding element of an air intake system of an engine is provided that is made of synthetic material. As a result of its foamed (wall) structure, the fluid guiding element has thermally insulating properties so that the air guided in operation through the fluid guiding element is not heated or only insignificantly heated, for example, by waste heat of the engine. In other words, the air stream that is guided within the fluid guiding element can be kept cool by the insulating properties of the fluid guiding element. In other words, the fluid guiding element transverse to the air guiding direction has a low thermal conductivity. Due to the thermal insulating properties of the fluid guiding element, additional insulating layers for encasing the fluid guiding element, such as aluminum foil, textile materials and the like, are made obsolete. The fluid guiding element can therefore be mounted in a simplified way in a motor vehicle and, at the same time, can be provided with a surface that, with respect to visual and haptic considerations, is of a high quality because it is smooth and free of bubbles, or substantially free of bubbles. The production costs for manufacturing the fluid guiding element can be significantly lowered due to the elimination of the additional encasement. This represents an advantage that is not to be neglected because the fluid guiding elements according to the invention are mass-produced articles.

As a material for the method any polymeric synthetic material, in particular thermoplastic material, can be employed. Melting of the polymer is carried out preferably in an extruder.

According to the invention, as a foaming agent any gas-forming and/or volume-enlarging substance can be employed. For example, a liquid gas, in particular liquid carbon dioxide, can be used that becomes gaseous with increasing temperature and leads to pores in the polymer, i.e., leads to a polymer foam. Such a foam formation is referred to as physical foaming.

“Molding of the melted polymer material with a foaming agent by forming a polymer foam” is to be understood as foaming and cooling of the polymer foam wherein the polymer material is molded by a mold. Preferably, several steps of the molding process are performed simultaneously so that a particularly fast and thus inexpensive production of the fluid guiding element can be achieved.

According to the invention, the foam-producing foaming agent is metered in such that a volume proportion of the foam (the bubbles) upon molding of the melted polymer material with the foaming agent to the fluid guiding element is adjusted such that it amounts to up to 50% of the total volume of the fluid guiding element.

In the method step a), preferably a polymer in the form of polypropylene (PP), polyamide (PA), polyethylene (PE) or polyurethane (PU) is used. In this way, a strongly insulating shape-stable fluid guiding element is achieved.

A particularly high stability of the fluid guiding element can be achieved according to the invention in that, for stabilizing the fluid guiding element, fibers are added to the melted polymer material prior to method step c). The fibers are preferably embodied in the form of carbon fibers, glass fibers or also synthetic or natural polymer fibers in order to further increase the strength of the fluid guiding element. The polymers may already contain fibers, for example, glass fibers.

As an alternative or in addition to the fibers, other stabilizing additives or aggregates, such as glass beads, graphite, carbon black and/or talcum, can also be added to the melted polymer material prior to method step c).

According to the invention, in particular a chemical gas forming agent, for example, sodium hydrogen carbonate and/or potassium hydrogen carbonate, can be used as a foaming agent. In this way, the pore size and the volume proportion of the pores in the total volume of the fluid guiding element can be adjusted in a simply and precisely. Liquid gases must not be stocked.

A particularly inexpensive production of the fluid guiding element is achieved in that the fluid guiding element in the method step c) is formed in a mono-layer configuration so that it is comprised only of one single layer.

In the method step c), a fluid guiding element can be molded that has a thickness of more than 4 mm, in particular a thickness between 5 mm and 20 mm, preferably between 5 mm and 15 mm, particularly preferred between 5 mm and 10 mm. The thickness of the fluid guiding element is to be understood as the gauge of the fluid guiding element, i.e., the width of the wall cross-section of the fluid guiding element.

Particularly preferred, molding in the method step c) is done by injection molding in an injection mold. In this way, the fluid guiding element is produced particularly true to size and precisely. Moreover, it is possible to employ injection molds, optionally after slight modification, that have been used up to now for producing solid fluid guiding elements.

The pressure during injection molding in the method step c) can be selected to be so high that the average pore size in the wall area of the fluid guiding element which is resting on the injection mold, i.e., in surface-near wall areas of the air guiding element, is smaller than the average pore size of the remaining injection-molded fluid guiding element. The average pore size of the wall area of the fluid guiding element contacting the injection mold is preferably maximally 60%, preferably maximally 40%, particularly preferred maximally 20%, of the average pore size of the remaining injection-molded fluid guiding element. The minimal pore size in the surface area of the fluid guiding element enables, on the one hand, a reduced air resistance as flow passes across the fluid guiding element. On the other hand, in this way the visual appearance and the haptic properties of the fluid guiding element can be improved.

The minimal average pore size in the wall area contacting the injection mold is achieved, on the one hand, by the pressure of the injection molding material during the injection molding process wherein the pressure causes compression and escape of gas of the fluid guiding element in its surface area. On the other hand, the injection molding material cools faster due to the contact with the injection mold than the remaining fluid guiding element. In other words, fewer bubbles in the area of the surface of the fluid guiding element are produced. The injection mold according to the invention can be actively cooled in order to minimize the surface-near pore formation.

As an alternative to injection molding, molding can also done by an extrusion method or a pultrusion method (pulling/extruding through a die). In this way, the molding tool can be embodied directly in the form of a foaming nozzle. The molding tool that is required for molding is therefore of a constructively simple design.

The fluid guiding element according to the invention of an air intake system of an internal combustion engine is formed of a foamed polymer material.

The fluid guiding element is preferably in the form of an air filter housing, a housing cover, for example, an air filter housing cover or air filter housing top part, a pipe or a pipe section.

The fluid guiding element is preferably made of PP, PA, PE and/or PU so that the fluid guiding element is particularly strongly insulating and shape-stable.

Preferably, the fluid guiding element comprises several fibers, in particular carbon fibers and/or glass fibers, which significantly increase the stability of the fluid guiding element.

Alternatively or additionally, the fluid guiding element can comprise other stabilizing aggregates.

The fluid guiding element can be manufactured particularly inexpensively when it is configured of a single layer.

The fluid guiding element has preferably a thickness of more than 4 mm, in particular a thickness of between 5 mm and 20 mm, preferably between 5 mm and 15 mm, especially preferred between 5 mm and 10 mm. Such a layer thickness leads to a good thermal insulation at comparatively minimal production costs.

In a particularly preferred embodiment of the invention, the average pore size in the outer wall area of the fluid guiding element is maximally 60%, preferably maximally 40%, especially preferred maximally 20%, of the average pore size of the remaining fluid guiding element. In this way, a friction-reduced guiding of the air through the fluid guiding element is achieved. Outer wall area is to be understood in this context as a boundary surface of the fluid guiding element.

The boundary surface can face radially outwardly or radially inwardly. Alternatively, in the wall area of the fluid guiding element the boundary surfaces can face radially inwardly and radially outwardly.

The fluid guiding element can be embodied as a guiding element for a liquid, in particular fuel and/or oil.

### BRIEF DESCRIPTION OF THE DRAWINGS

Further features and advantages of the invention result from the following detailed description of an embodiment of the invention, from the Figures of the drawing showing details important to the invention, as well as from the claims.

The features illustrated in the drawing are illustrated such that the special features according to the invention are clearly visible. In variants of the invention, the different features can be realized individually or several of them in any combination.

FIG. 1 shows a schematic illustration of an internal combustion engine and an air intake system of the engine.

FIG. 2 is a longitudinal section of a schematic illustration of a part of the air intake system of FIG. 1.

### DESCRIPTION OF PREFERRED EMBODIMENTS

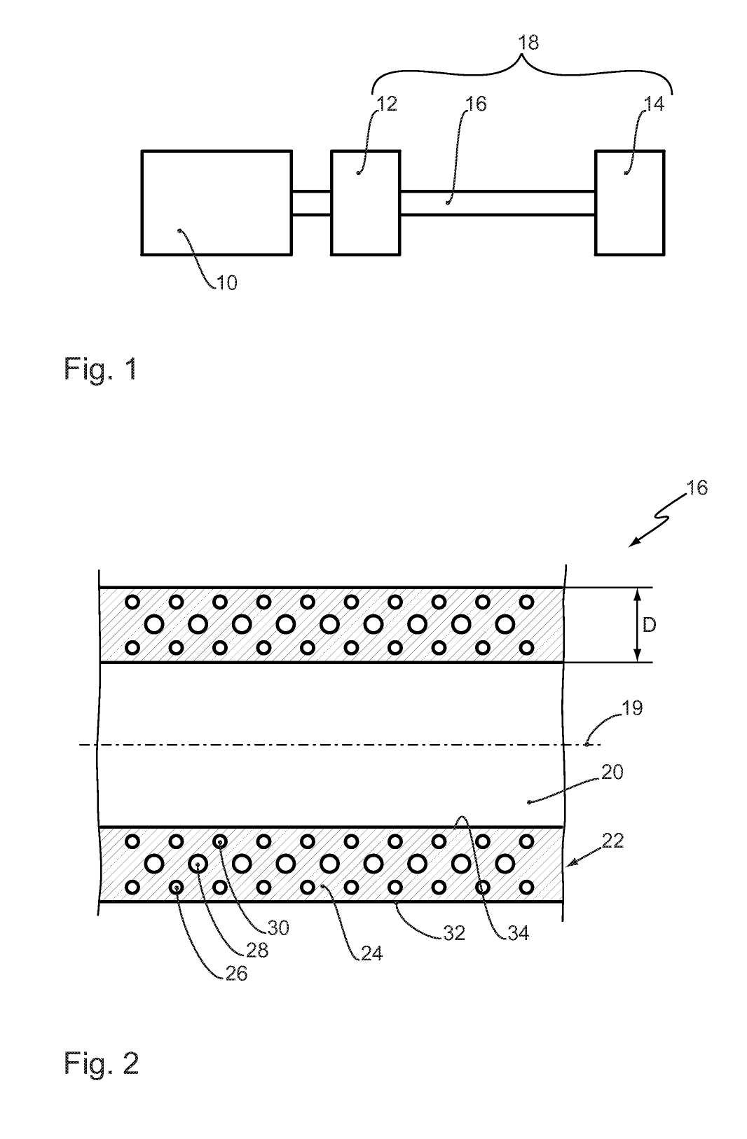

FIG. 1 shows schematically an internal combustion engine 10 of a motor vehicle. The internal combustion engine 10 is provided with a flow control device 12, for example, in the form of a throttle. The flow control device 12 is supplied with air for the internal combustion engine 10 that is coming from an air filter 14. The air filter 14 is connected by means of a fluid guiding element 16 in the form of a pipe, more precisely an intake pipe, fluidically with a flow control device 12. The flow control device 12, the fluid guiding element 16, and the air filter 14 constitute an air intake system 18 of an engine. It is understood that the air intake system 18 can also be designed differently. For example, the air intake system 18 can comprise, in a way not described in more detail, an (exhaust gas) turbocharger, a charge air cooler or other components that are connected to each other at least partially by fluid guiding elements 16.

In order to achieve a high efficiency, cold air must be supplied to the internal combustion engine 10. The air, therefore, may not be heated in the air intake system 18 of an engine, for example, by the heat (waste heat of the engine) that is released by the internal combustion engine 10. The air intake system 18 has therefore fluid guiding elements 16 that are embodied to be thermally insulated. In this context, the fluid guiding elements 16 are therefore embodied of a synthetic foam, i.e., a polymer foam.

FIG. 2 shows a cross-section of the fluid guiding element 16 as an example of the insulating configuration of the fluid guiding elements. The fluid guiding element 16 is embodied with rotational symmetry relative to its longitudinal axis 19. The fluid guiding element 16 can therefore be produced easily. More complex shapes can be produced by injection molding.

The fluid guiding element 16 has an inner tubular area 20 and a pipe wall 22 surrounding the inner tubular area 20. The fluid guiding element 16 is monolithic, i.e., is of a single layer configuration.

The pipe wall 22 is made of foamed synthetic material, i.e., made of a polymer foam. The pipe wall 22 comprises therefore a body 24 that is embodied of synthetic material. The body 24 has interspersed therein several pores of which, for reasons of simplicity, only a first pore 26, a second pore 28, and a third pore 30 are provided with reference characters. The pores 26, 28, 30 have different pore sizes or different pore volumes. The pores 26, 28, 30 can be spherical or, depending on the parameter selection during molding, can have any non-round shape.

The first pore 26 is formed in an outer wall area 32 and the third pore 30 in an inner wall area 34 of the pipe wall 22. The first pore 26 and the third pore 30 have a smaller pore size than the second pore 28. Due to the smaller pore size in the outer wall area 32 and the inner wall area 34, an attractive visual appearance of the pipe wall 22 and a friction-reduced flow across the inner tubular area 20 are enabled. The smaller pore size in the outer wall area 32 and in the inner wall area 34 are obtained by high pressure during an injection molding method when manufacturing the fluid guiding element 16.

The fluid guiding element 16 has a thickness D of 5 mm to 10 mm. In this way, the fluid guiding element 16 is produced inexpensively, but has however at the same time good insulating properties transverse to the flow direction, i.e., transverse to its longitudinal axis 19 as well as a functionally sufficiently high stability relative to mechanical loading.

In summarizing the above, the invention concerns a fluid guiding element. The fluid guiding element serves for transporting air to an internal combustion engine. It is made of foamed synthetic material. The foamed synthetic material is molded by a method according to the invention from a polymer melt to which is added a foaming agent prior to molding the fluid guiding element. As a foaming agent, physical foaming agents, preferably however chemical foaming agents, can be used. Molding of the fluid guiding element is realized preferably by an injection molding method. An air intake system of an (internal combustion) engine according to the invention comprises at least one of the aforementioned fluid guiding elements.

While specific embodiments of the invention have been shown and described in detail to illustrate the inventive principles, it will be understood that the invention may be embodied otherwise without departing from such principles.

What is claimed is:

1. A method for producing a fluid guiding element of an air intake system of an engine, the method comprising:
a) melting a polymer to a melted polymer material;
b) adding a foam-generating foaming agent to the melted polymer material;
c) molding the melted polymer material together with the foaming agent to a fluid guiding element by forming a polymer foam.

2. The method according to claim 1, further comprising selecting the polymer in method step a) from polypropylene (PP), polyamide (PA), polyethylene (PE) or polyurethane (PU).

3. The method according to claim 1, further comprising, prior to method step c), adding several fibers to the melted polymer material for stabilizing the fluid guiding element.

4. The method according to claim 1, further comprising selecting the foaming agent in method step b) to be a chemical gas forming agent.

5. The method according to claim 4, wherein the chemical gas forming agent is sodium hydrogen carbonate; potassium hydrogen carbonate; or a mixture of sodium hydrogen carbonate and potassium hydrogen carbonate.

6. The method according to claim 1, wherein the fluid guiding element in method step c) is formed as a single layer.

7. The method according to claim 1, wherein in method step c) the fluid guiding element is formed to have a thickness of more than 4 mm.

8. The method according to claim 7, wherein the thickness is between 5 mm and 20 mm.

9. The method according to claim 8, wherein the thickness is between 5 mm and 15 mm.

10. The method according to claim 9, wherein the thickness is between 5 mm and 10 mm.

11. The method according to claim 1, wherein molding in method step c) is carried out by injection molding in an injection mold.

12. The method according to claim 11, further comprising selecting a pressure during injection molding to be so high that an average pore size of a wall area of the fluid guiding element contacting the injection mold is maximally 60% of an average pore size of a remaining portion of the fluid guiding element.

13. The method according to claim 12, wherein the average pore size of the wall area of the fluid guiding element is maximally 40% of the average pore size of the remaining portion of the fluid guiding element.

14. The method according to claim 13, wherein the average pore size of the wall area of the fluid guiding element is maximally 20% of the average pore size of the remaining portion of the fluid guiding element.

15. A fluid guiding element of an air intake system of an internal combustion engine, the fluid guiding element comprised of a foamed polymer material.

16. A fluid guiding element according to claim 15, wherein the fluid guiding element is an air filter housing, a cover, a pipe or a pipe section.
